(19) United States
(12) Patent Application Publication
(10) Pub. No.: US 2004/0016807 A1
(43) Pub. Date: Jan. 29, 2004

(54) Device comprising a chip card

(76) Inventor: Ulrich Huber, Munchen (DE)

Correspondence Address: BELL, BOYD & LLOYD, LLC, P. O. BOX 1135, CHICAGO, IL, 60690-1135, US

(21) Appl. No.: 10/343,818

(22) PCT Filed: Jul. 31, 2001
(86) PCT No.: PCT/DE01/02907

(30) Foreign Application Priority Data
Aug. 2, 2000 (DE) 100 37 744.0

(51) Int. Cl. G06K 7/06

(52) U.S. Cl. 235/441

(57) ABSTRACT

The invention relates to a device comprising a housing, a printed circuit board (2) arranged inside said housing, and a chip card (3). Said chip card is electrically connected to the printed circuit board by means of a contact spring (1) and can be removed from the housing. The printed circuit board and the chip card directly lie, with a respective lateral surface thereof, one on top of the other or they are closely arranged next to one another. The contact spring, at least in one section, extends inside a recess (10) located in a housing wall (9) and/or in the printed circuit board.

The invention relates to a device having a housing, having a printed circuit board which is arranged in the housing, and having a smart card which is electrically connected to the printed circuit board by means of a contact spring and can be removed from the housing.

The most widely differing electronic devices, in particular relatively small mobile devices, are ever more frequently being equipped with smart cards, which either serve to authorize the user, or else are used as an additional memory and/or program medium. Examples of this are the SIM cards that are used in mobile telephones, so-called smart cards or else MMCs (multi media cards), which are essentially memory cards, and are used for storing relatively large amounts of audio or video data in audio or video devices, for example cameras. Normally, the contact between the printed circuit board and the contact surface of the smart card is made via so-called contact springs, that is to say in the form of pressure contacts. The contact spring is a suitably bent wire or sheet-metal spring which is attached to the printed circuit board and which, when the smart card is installed, presses against a contact surface on the smart card by virtue of the intrinsic stress in the spring. In the following text, the expression smart card should in this context be understood as meaning all such interchangeable memory and/or program media with corresponding contact surfaces.

In many cases, devices such as this have only one smart card, but they may also have a number of smart cards, for example for different applications. In the same way, depending on the nature of the smart card, a number of parallel contacts may be provided between the printed circuit board and the contact surfaces on the smart card via a number of contact springs. It is self-evident that devices such as these are likewise covered by the invention described in the following text.

Until now, an arrangement in which the contact spring was physically located between the printed circuit board and the smart card has been chosen for making contact between the smart card and the printed circuit board. This means that the smart card is located relatively far away from the printed circuit board, and parallel to it, and is held in the housing in appropriate guides. The smart card is in this case arranged with respect to the printed circuit board such that the contact surfaces on the smart card point in the direction of the printed circuit board. The distance between the printed circuit board and the smart card is bridged by the contact spring. The physical height of the contact spring, or of a contact set comprising a number of contact springs, governs the distance between the printed circuit board and the smart card. The volume between the printed circuit board and the smart card can be used only with difficulty, and leads to a considerable volume being consumed that is not used. The physical height of the contact set is thus a factor that also governs the size of the device, to a particular extent. This runs counter to the desired further miniaturization, in particular of mobile handheld devices such as mobile radios or PDAs.

U.S. Pat. No. 4,675,516 A1 discloses a card reader for electronic memory cards, in which a memory card is supported against a wall and has contact surfaces on its side which faces away from the wall. Contract springs, which run through a cut out in an insulating element in the form of a board, make contact with these contact surfaces. The contact springs produce an electrical connection between the contact surfaces on the memory card and an electronic processing device. In this case, the element which is in the form of a board is located at a considerable distance from the memory card, so that in this case as well, this results in the disadvantage that a considerable volume is required owing to the profile of the contact springs.

One object of the present invention is thus to provide an alternative to this prior art, which allows further miniaturization of the entire device while ensuring that the contact can be made between the smart card and the printed circuit board reliably and at low cost.

This object is achieved in that one side surface in each case of the printed circuit board and of the smart card rest directly on one another or lie at a short distance from one another, and, at least in a section along its spring movement between the printed circuit board and the smart card, the contact spring runs in a cutout in one housing wall and/or in the printed circuit board. In this case, the term “between” does not refer to the spatial arrangement between the printed circuit board and the smart card, but in general to the conductor routing between the contact points on the printed circuit board and on the smart card.

According to the invention, the space between the printed circuit board and the smart card is saved virtually completely in this way. The spring movement of the contact spring or of the contact springs is “concealed” in a space-saving manner in a cutout which is incorporated specifically for this purpose in a housing wall, that is to say the contact spring is integrated in the housing over at least a major proportion of its spring movement.

In one particular preferred exemplary embodiment, the device is designed such that the contact spring engages, from the printed circuit board, around one edge of the smart card, and makes contact with the smart card on a front side which faces away from the printed circuit board. In this case, the contact spring engages around the edge of the smart card at least along a section on which the contact spring runs, and/or runs along that side of the smart card which faces away from the printed circuit board, in a cutout in one housing wall. In this case, the contact spring can either be bent such that it is bent around the edge of the smart card, originating from the printed circuit board and from one side of the smart card to the other. The contact spring may, however, also be mounted in a contact spring block or the like which, for example, extends along one edge of the smart card on the printed circuit board, and the contact spring or the individual contact springs of the contact spring block runs or run from the contact spring block essentially parallel to the smart card along that side of the smart card which faces away from the printed circuit board. To this extent, any contact spring block that may be provided is a component of the contact spring.

In this first exemplary embodiment, and in contrast to the previously known ways of making contact, the rear face of the smart card rests directly on or slightly above the printed circuit board. This means that the smart card is inserted the other way round.

The cutouts are in this case incorporated in the housing wall, in which case these cutouts can either be milled out or can be integrally formed at the same time as the molding of the housing wall. This embodiment can thus be produced at relatively low cost. In consequence, with a smart card being accommodated in the normal way in a smart card area on the rear face of a mobile radio, all that is necessary is to incorporate appropriate cutouts in the lower shell of the device.

In a second preferred exemplary embodiment, the contact spring runs from that side which faces away from the smart card at least in one section in a cutout, passes through from one side of the printed circuit board to the other side of the printed circuit board, in the printed circuit board, and makes contact with the smart card on the front side which faces the printed circuit board. This means that the cutout in this case forms an aperture in the printed circuit board. There is no need for special cutouts in the housing wall. However, in this version, space is lost on and in the printed circuit board itself.

The cutout is preferably a groove or a continuous slot running along that section of the contact spring. There are various options where there are a number of contact springs that run parallel to one another.

In one preferred exemplary embodiment, the contact springs each run in separate grooves or separate slots alongside one another. In particular if the grooves or cutouts are accommodated in housing, for example in accordance with the first preferred exemplary embodiment mentioned above, this has the advantage that the cutouts are themselves in each case only relatively small and do not adversely affect the strength of the housing wall.

Alternatively, of course, a number of the contact springs may also run parallel in a common cutout. This embodiment can be produced at less cost and is particularly appropriate when the housing wall is in any case thick enough or is composed of a material such that relatively large cutouts are permissible without any adverse affects on robustness.

The invention will be explained in more detail in the following text with reference to the attached drawings and using exemplary embodiments. The features illustrated there and the features which have already been described above may be significant to the invention not only in the stated combinations but also individually or in other combinations. In the figures:

FIG. 1 shows a schematic partial longitudinal section through a printed circuit board which is arranged a short distance underneath one housing wall of the device, and of a smart card which is incorporated between the housing wall and the printed circuit board;

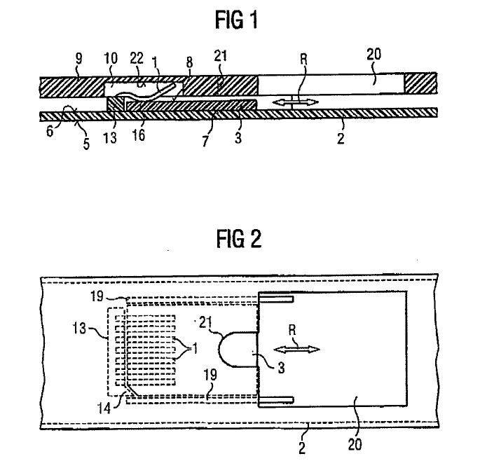

FIG. 2 shows a plan view of the arrangement shown in FIG. 1, from the housing wall side;

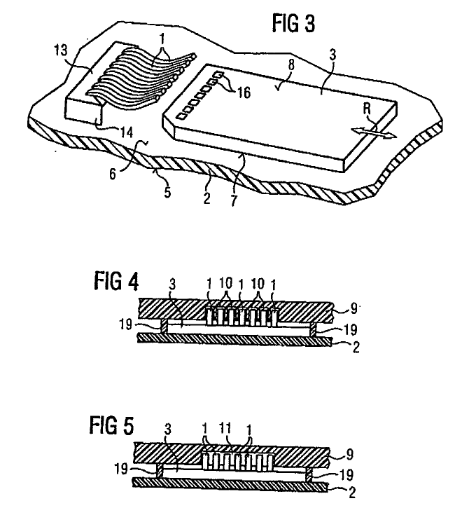

FIG. 3 shows a perspective view of a printed circuit board with a smart card arranged on it, and a contact set having a number of contact springs;

FIG. 4 shows a schematic partial cross section through a printed circuit board, a smart card arranged on it and a housing wall located above the smart card, with individual grooves for a number of contact springs which run parallel;

FIG. 5 shows a schematic partial cross section as in FIG. 4, but with a common broader cutout in the housing wall for a number of contact springs which run parallel;

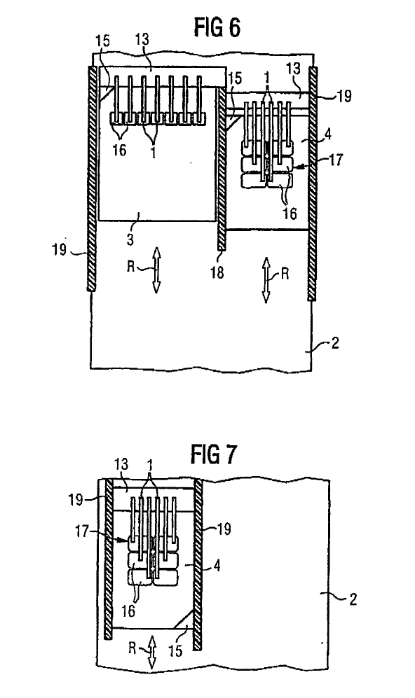

FIG. 6 shows a schematic illustration of the arrangement of two smart cards, which are arranged parallel alongside one another, on one printed circuit board;

FIG. 7 shows a schematic illustration of the arrangement of a smart card on a printed circuit board, with the smart card being locked in position;

FIG. 8 shows a schematic partial longitudinal section as in FIG. 1, but with a contact spring which runs through a cutout in the printed circuit board.

FIG. 1 shows, schematically, a typical installation of a smart card 3 in a device based on a first exemplary embodiment according to the invention. In this case, the printed circuit board 2 of the device is located at a relatively short distance underneath a housing wall 9, in this case the lower shell of a conventional mobile radio. The rear face 7 of the smart card 3 rests directly on the upper face 6 of the printed circuit board 2, pointing toward the housing wall 9.

A contact spring block 13 which has a number of contact springs is arranged on one edge of the smart card 3 on this upper face 6 (FIG. 3). The contact springs 1 (including the contact spring block 13) in this case engage around the edge of the smart card 3, as seen from the printed circuit board 2.

There are cutouts 10, in which the contact springs 1 run in a concealed manner, in the area of the contact springs 1 in the housing wall 9.

The contact surfaces 16 are located on the front face 8 of the smart card 3, facing away from the printed circuit board 2. The individual contact springs 1 are bent such that, starting from the contact spring block 13, they initially run in a curved shape in the direction of the smart card 3 and press against the contact surfaces 16 at their lowest point, and then once again run away from the smart card 3 in the direction of the housing wall 9. At their free end, the contact springs 1 each abut against the base 22 of the cutout 10 in the housing wall 9. This contact pressure of the contact spring ends against the cutout base 22 ensures a defined contact force for the contact springs 1 on the respective contact surface 16 of the smart card 3.

The entire arrangement is illustrated once again, from above, in FIG. 2.

As can be seen well in FIGS. 1 and 2, the smart card 3 may be removed from the device by pushing the smart card 3 in the direction of the arrow R away from the contact spring block 13 on the printed circuit board 2, under a removal opening 20 in the housing wall 9. For this purpose, the housing wall has an ejection opening 21, which is adjacent to the removal opening 20, through which the user can use a finger to press against the smart card 3, in order to remove the smart card.

The smart card 3 is inserted in the opposite sequence, with the smart card 3 being placed on the printed circuit board 2 in the removal opening 20, and being pushed under the contact springs 1. In order to position the smart card correctly, there are guide edges 19 at the side of the smart card, and these are arranged either on the printed circuit board 2 or on the housing wall 9. Furthermore, the contact spring block 13 has a positioning corner 14, which is matched to one corner section of the smart card 3, so that it is impossible to insert the smart card 3 into the housing of the device other than in the correct orientation.

In the exemplary embodiments shown in FIGS. 2 and 3, this positioning corner 14 is integrated directly in the contact spring block 13. However, of course, it is also possible, as illustrated in FIGS. 6 and 7, for the positioning corner 18 to be arranged separately on the printed circuit board 2 or on the housing wall 9.

FIGS. 4 and 5 each show a cross section through the embodiment shown in FIG. 1, at the level of the contact springs 1.

FIG. 4 in this case shows an exemplary embodiment in which the contact springs 1 are located in individual grooves 10, which are arranged parallel in the housing wall 9. FIG. 5 shows a variant with a larger, broader cutout 11, in which all the contact springs 1 run side by side, together. The version shown in FIG. 4 is somewhat more complex to produce than the version shown in FIG. 5. Owing to the smaller size of the cutouts 10, it is possible, however, to reduce the wall thickness to less than the normal thickness in the area of the grooves 10 without any adverse effect on the mechanical robustness of the housing wall 9. The version shown in FIG. 5 is particularly suitable for relatively thick housing walls 9 or housing walls 9 composed of particularly robust material, for example of metal, or if the material does not allow any filigrane structure during the molding of the housing.

FIGS. 6 and 7 show, schematically, various arrangements of the smart card or of a number of smart cards alongside one another on a printed circuit board 2.

FIG. 6 shows two different smart cards 3, 4, namely an MMC 3 and a SIM card 4, arranged alongside one another in the printed circuit board 2. The two smart cards 3, 4 can in each case once again be pushed under the contact springs 1 in the direction of the arrow R from the side of the smart card 3, 4 that is opposite the contact spring block 13, and can be pulled out again. The smart cards 3, 4 are in each case guided by a guide edge 19, which is located on the outer edge, and by a central guide web 18, which separates the two smart cards 3, 4 from one another. In order to orient the smart cards 3, 4 correctly, there are once again positioning corners 15 in each case in the area of the contact spring blocks 13, which engage in corresponding corner sections of the smart cards 3, 4.

As is illustrated in FIG. 6, the method according to the invention allows both MMCs 3 with a number of contact surfaces 16 that are arranged parallel alongside one another as well as the normal SIM cards to make contact with a contact surface array 17, comprising a number of contact surfaces 16 which are arranged alongside one another in rows and columns.

FIG. 7 shows a variant in which the positioning corner 15 is at the same time used for locking the smart card, in this case a SIM card 4. In this case, the positioning corner 15 is mounted in a sprung manner on or in the printed circuit board 2, and can be pressed down in order to insert the smart card 4. As soon as the smart card 4 has been inserted in the correct position, the positioning corner 15 is pushed upwards again by the spring force, and holds the smart card 4 in its position.

The invention described here makes it possible to make contact between a printed circuit board and a smart card in a particularly compact manner, in such a way that it can be integrated particularly well in a device, and such that its size is optimized. The integration of the contact springs in the housing wall or in the printed circuit board allows the wasted space to be considerably reduced, and thus allows the device to be further miniaturized.

FIGS. 1 and 2. This means that the housing wall 9 has a removal opening 20 as well as an ejection opening 21, so that the user can push against the inserted smart card 3 through the ejection opening 21, can push the smart card 3 underneath the removal opening 20, and can remove it from the removal opening 20.

The design in this exemplary embodiment also has a positioning corner (not shown) or the like, of course, in order to ensure that the smart card 3 is inserted in the correct orientation.

The invention described here makes it possible to make contact between a printed circuit board and a smart card in a particularly compact manner, in such a way that it can be integrated particularly well in a device, and such that its size is optimized. The integration of the contact springs in the housing wall or in the printed circuit board allows the wasted space to be considerably reduced, and thus allows the device to be further miniaturized.

1. A device having a housing, having a printed circuit board (2) which is arranged in the housing, and having a smart card (3, 4) which is electrically connected to the printed circuit board (2) by means of a contact spring (1) and can be removed from the housing, characterized in that one side surface (6, 7, 8) in each case of the printed circuit board (2) and of the smart card (3, 4) rest directly on one another or lie at a short distance from one another, and, at least in a section along its spring movement between the printed circuit board and the smart card, the contact spring (1) runs in a cutout (10, 11, 12) in one housing wall (9).

2. The device as claimed in claim 1, characterized in that the contact spring (1) engages, from the printed circuit board (2), around one edge of the smart card (3, 4), and makes contact with the smart card (3, 4) on a side (8) which faces away from the printed circuit board (2), and in that the contact spring (1) engages around the edge of the smart card (3, 4) at least along a section on which the contact spring (1) runs, and/or runs along that side (8) of the smart card (3, 4) which faces away from the printed circuit board (2), in a cutout (10, 11) in one housing wall (9).

3. The device as claimed in claim 1, characterized in that the contact spring (1) runs from that side (5) of the printed circuit board (2) which faces away from the smart card (3) at least in one section in a cutout (12), which forms an aperture (12) and passes through from one side (5) of the printed circuit board (2) to the other side (6) of the printed circuit board (2), in the printed circuit board (2), and makes contact with the smart card (3) on the side (8) which faces the printed circuit board (2).

4. The device as claimed in one of claims 1 to 3, characterized in that the cutout (10, 12) is a groove (10) or a slot (12) which runs along the section of the contact spring (1).

5. The device as claimed in one of claims 1 to 4, characterized by a number of contact springs (1) which run parallel to one another.

6. The device as claimed in claim 5, characterized in that a number of the contact springs (1) each run in a separate groove (10) or in a separate slot (12).

7. The device as claimed in claim 5 or 6, characterized in that a number of the contact springs (1) run parallel in a common cutout (11).

8. The device as claimed in one of claims 1 to 7, characterized in that the device is a mobile handheld device.

9. The device as claimed in claim 8, characterized in that the device is a mobile radio. 10. The device as claimed in one of claims 1 to 9, characterized in that the smart card is a SIM card (4) or an MMC (3).
